(19) United States
(12) Patent Application Publication
(10) Pub. No.: US 2012/0273212 A1
(43) Pub. Date: Nov. 1, 2012

(54) FLANGE SEPARATION AND RETRIEVAL TOOL

(75) Inventors: Paul Edward Anderson, Peyton, CO (US); Wyatt Chase Breidenthal, Houston, TX (US); Eric Joseph Munstereifel, Cypress, TX (US)

(73) Assignee: BP CORPORATION NORTH AMERICA INC., Houston, TX (US)

(21) Appl. No.: 13/455,810

(22) Filed: Apr. 25, 2012

Related U.S. Application Data
(60) Provisional application No. 61/479,157, filed on Apr. 26, 2011.

(51) Int. Cl. E21B 29/12; B23P 19/00

(52) U.S. Cl. 166/340; 29/700; 29/426.1

(57) ABSTRACT

A tool for separating a first flange from a second flange comprises an annular body disposed about a central axis and defining a flange capture cavity. In addition, the tool comprises a plurality of circumferentially-spaced wedge members moveably coupled to the body. Further, the tool comprises a first actuation assembly configured to move each wedge member from a first position radially withdrawn from the capture cavity to a second position radially advanced into the capture cavity.

### CROSS-REFERENCE TO RELATED APPLICATIONS

This application claims benefit of U.S. provisional patent application Ser. No. 61/479,157 filed Apr. 26, 2011, and entitled “Flange Separation and Retrieval Tool,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

The invention relates generally to remedial devices and methods. More particularly, the invention relates to devices and methods for separating a flange joint and removing one flange of the flange joint.

2. Background of the Technology

In hydrocarbon drilling and production operations, it is common to have tubulars coupled together with mating flanges that form a flange joint. During maintenance and/or remedial operations, it may be necessary to separate the connected flanges to access passages or bores in the equipment, to advance other tools or devices through the equipment, to break down or remove the equipment, or to prepare one flange for connection to a different piece of equipment. For example, in the event of a subsea blowout, it may be necessary to separate a flanged connection between a riser and a riser flex joint so that a different piece of equipment can then be connected to the riser flex joint.

On land, such remedial operations may be relatively easy if the flange connection can be directly accessed and engaged at the surface with impact wrenches, tongs, or other suitable separation equipment. However, if the flange connection is remote from the associated surface operations (e.g., disposed downhole or subsea), it may be difficult to sufficiently separate and remove a flange from its mating flange.

Accordingly, there remains a need in the art for devices and methods to separate and remove one flange from its mating flange. Such devices and methods would be particularly well-received if they were suitable for remote, subsea remedial operations.

### BRIEF SUMMARY OF THE DISCLOSURE

These and other needs in the art are addressed in one embodiment by a tool for separating a first flange from a second flange. In an embodiment, the tool comprises an annular body disposed about a central axis and defining a flange capture cavity. In addition, the tool comprises a plurality of circumferentially-spaced wedge members moveably coupled to the body. Further, the tool comprises a first actuation assembly configured to move each wedge member from a first position radially withdrawn from the capture cavity to a second position radially advanced into the capture cavity.

These and other needs in the art are addressed in another embodiment by a method for separating a first flange of a subsea flange joint from a second flange of the subsea flange joint. In an embodiment, the method comprises (a) lowering a flange splitting tool subsea. The tool comprises an annular body disposed about a central axis and defining a flange capture cavity. The tool also comprises a plurality of circumferentially-spaced wedge members moveably coupled to the body. Each wedge member includes a pair of flanking surfaces defining an edge. In addition, the method comprises (b) positioning the first flange within the capture cavity. Further, the method comprises (c) aligning the edge of each wedge member with an interface between the first flange and the second flange. Still further, the method comprises (d) urging the wedge members radially inward between the first flange and the second flange after (c).

These and other needs in the art are addressed in another embodiment by a method for operating a flange separation tool. In an embodiment, the method comprises (a) positioning a flange separation tool proximal to a subsea flange joint including a first flange coupled to a second flange. The tool comprises an annular body disposed about a central axis and defining a flange capture cavity. The tool also comprises a first wedge member moveably couple to the body and a second wedge member moveably coupled to the body and circumferentially spaced from the first wedge member. Each wedge member includes a radially inner edge. In addition, the method comprises (b) receiving the first flange into the capture cavity. Further, the method comprises (c) adjusting the axial position of the wedge members relative to an interface between the first flange and the second flange. Still further, the method comprises (d) moving the first wedge member radially inward until the edge of the first wedge member engages the interface. Moreover, the method comprises (e) moving the second wedge member radially inward after (d) until the edge of the second wedge member engages the interface. The method also comprises (f) simultaneously moving each wedge member radially inward between the first wedge member and the second wedge member after (e).

Thus, embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a top perspective view of an embodiment of a subsea flange splitter and retrieval tool in accordance with the principles described herein;

FIG. 2 is a top perspective view of the tool of FIG. 1 in an opened position;

FIG. 3 is a bottom view of the tool of FIG. 1;

FIG. 4 is a bottom perspective view of the tool of FIG. 1;

FIG. 5A is a schematic front view of the locking mechanism of FIG. 1 in the “locked” position;

FIG. 5B is a schematic front view of the locking mechanism of FIG. 1 in the “unlocked” position;

FIG. 6 is a schematic view of the base actuation assembly of FIG. 1;

FIG. 7 is a partial perspective cross-sectional view of the tool of FIG. 1;

FIG. 8 is an enlarged view of the wedge members of FIG. 7;

FIG. 9 is an enlarged side view of one of the wedge members of FIG. 7;

FIG. 10 is a schematic view of the wedge member actuation system of FIG. 1;

FIGS. 11 and 12 are schematic views of the tool of FIG. 1 being deployed subsea to a subsea flange joint;

FIG. 13 is a cross-sectional view of the tool of FIG. 1 being lowered onto the subsea flange joint of FIGS. 11 and 12;

FIG. 14 is a top view of the tool of FIG. 1 being lowered onto the subsea flange joint of FIGS. 11 and 12;

FIG. 15 is a partial cross-sectional view of the tool of FIG. 1 illustrating the alignment of one wedge member with the subsea flange joint of FIGS. 11 and 12;

FIG. 16 is a partial cross-sectional view of the tool of FIG. 1 illustrating the actuation of the wedge member of FIG. 15 and separation of the upper flange of the flange joint of FIGS. 11 and 12;

FIG. 17 is a cross-sectional view of the tool of FIG. 1 removing the upper flange of the flange joint of FIGS. 11 and 12; and

FIG. 18 is a perspective view of the tool of FIG. 1 in the open position being disposed about the flange joint of FIGS. 11 and 12.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to. . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

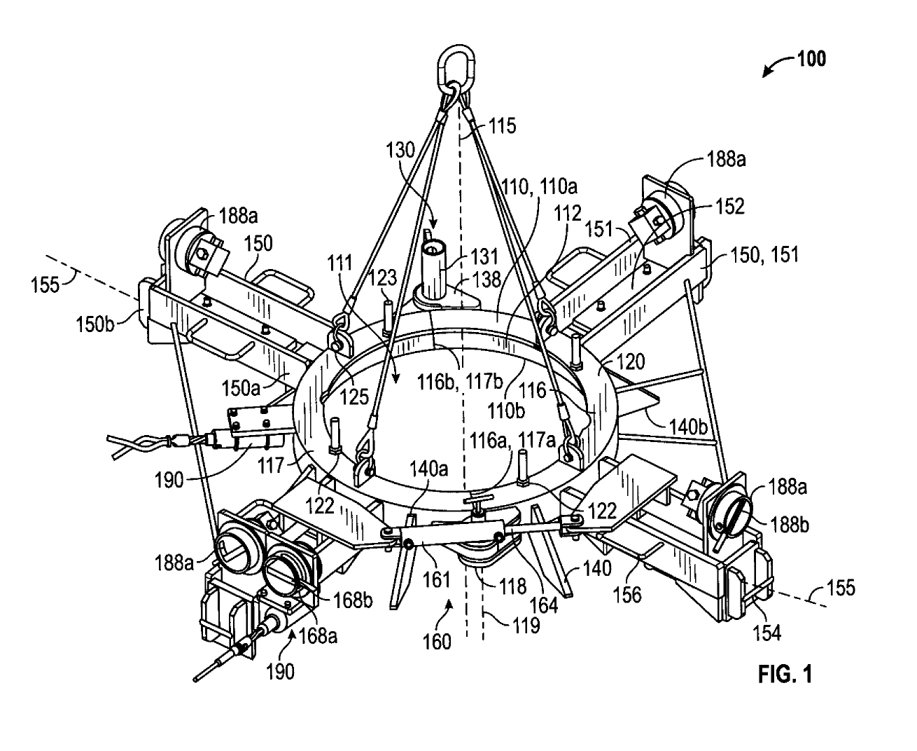

Referring now to FIGS. 1-4, an embodiment of a flange splitter and retrieval tool 100 is shown. In general, tool 100 is employed to separate and retrieve a flange from a subsea flange joint. For example, tool 100 may be employed to remove the flange at the lower end of a riser from the mating flange at the upper end of a riser flex joint. In this embodiment, tool 100 includes an annular frame or body 110, a body actuation assembly 160 coupled to body 110, a plurality of wedge members 170 moveably coupled to body 110, and a wedge member actuation assembly 180 coupled to body 110 and wedge members 170. As will be described in more detail below, body actuation assembly 160 controllably opens and closes body 110 to receive the flange to be separated and retrieved, and wedge member actuation assembly 180 controllably moves wedge members 170 between two mating flanges to urge them apart during separation and retrieval operations.

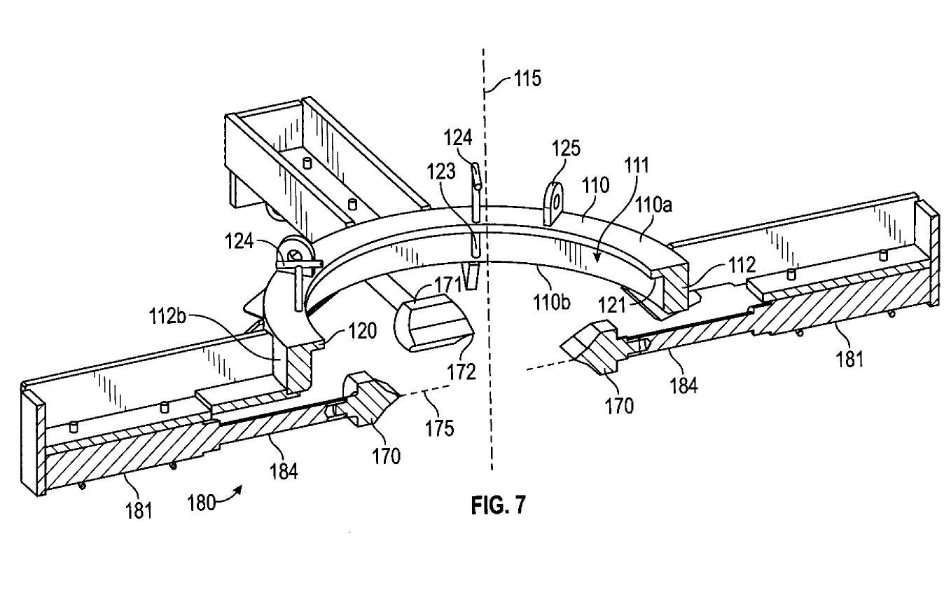

Referring still to FIGS. 1-4, ring-shaped body 110 is disposed about a central axis 115 and has a first or upper end 110a and a second or lower end 110b. In addition, body 110 defines a round flange capture cavity 111 extending axially between ends 110a, b. As best shown in FIG. 7, in this embodiment, body 110 has an inverted L-shaped cross-section including a first portion 112 extending axially from lower end 110b and a second portion 120 extending radially inward from first portion 112 at upper end 110a. A radially inner annular shoulder 121 is formed at the intersection of portions 112, 120.

Referring again to FIGS. 1-4, first portion 112 has a radially inner surface 112a and a radially outer surface 112b. Inner surface 112a is cylindrical with the exception of an annular bevel 113 at lower end 110b. As will be described in more detail below, bevel 113 defines a frustoconical surface 114 at lower end 110b that facilitates the axial advancement of a flange into capture cavity 111. Accordingly, frustoconical surface 114 may also be referred to as a “guide surface.”

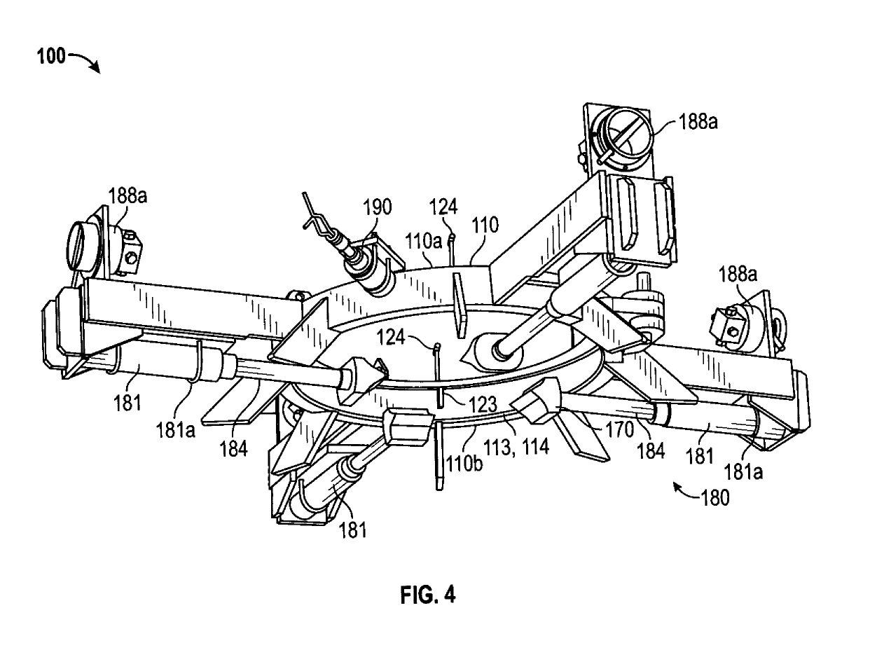

Second portion 120 includes a plurality of circumferentially-spaced internally threaded through bores 122. In this embodiment, four uniformly circumferentially-spaced bores 122 are provided (i.e., bores 122 are angularly spaced 90° apart about axis 115). Bores 122 extend axially through second portion 120 from upper end 110a to shoulder 121. Externally threaded members or bolts 123 are threaded into bores 122. Rotation of bolts 123 in one direction causes bolts 123 to move axially downward relative to second portion 120, and rotation of bolts 123 in the opposite direction causes bolts 123 to move axially upward relative to second portion 120. As best shown in FIGS. 4 and 7, in this embodiment, the upper end of each bolt 123 comprises a T-handle 124 that extends axially from second portion 120. T-handles 124 enable rotation of bolts 123 with subsea remotely operated vehicles (ROVs).

A plurality of circumferentially-spaced connection members 125 are coupled to second portion 120 and extend axially from upper end 110a. In this embodiment, four uniformly circumferentially-spaced connection members 125 are provided (i.e., connection members 125 are angularly spaced 90° apart about axis 115). Each connection member 125 includes an eye employed to secure the lower end of a deployment cable or wireline to body 110.

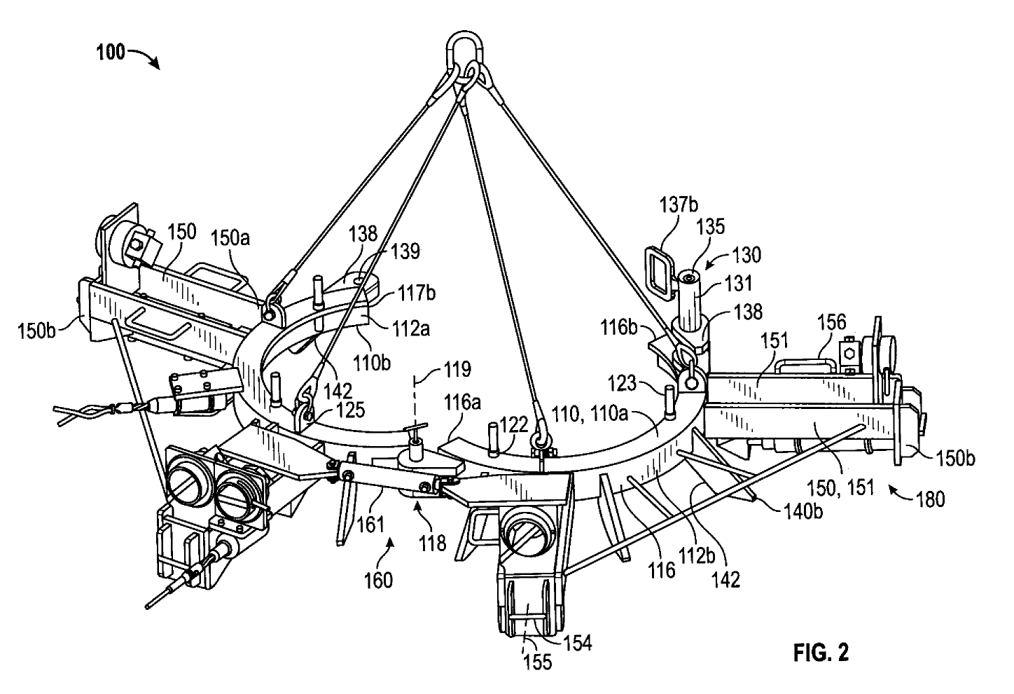

Referring now to FIGS. 1 and 2, in this embodiment, body 110 is a split-ring comprising two segments 116, 117, each segment 116, 117 extending angularly through 180° about axis 115. Segment 116 has ends 116a, b, and segment 117 has ends 117a, b that are coupled to ends 116a, b, respectively. More specifically, ends 116a, 117a are coupled together with a hinge joint 118 having an axis of rotation 119 parallel to axis 115. Hinge joint 118 allows segments 116, 117 to pivot or rotate about axis 119, but prevents ends 116a, 117a from moving translationally relative to each other.

Ends 116b, 117b are releasably coupled together with a locking mechanism 130 having a “locked” position securing ends 116b, 117b together (FIGS. 1, 3, and 4), and an “unlocked” position allowing ends 116b, 117b to move apart (FIG. 2). The direction of movement of ends 116b, 117b and corresponding segments 116, 117 is generally within a plane perpendicular to hinge axis 119. When locking mechanism 130 is unlocked, segments 116, 117 are free to pivot about axis 119, however, when locking mechanism 130 is locked, segments 116, 117 are fixed relative to each other and prevented from pivoting about axis 119. Accordingly, tool 100, body 110, and segments 116, 117 may be described as having a “closed” position with ends 116b, 117b together and body 110 completely encircling capture cavity 111 (FIGS. 1, 3, and 4), and an “opened” position with ends 116b, 117b spaced apart (FIG. 2), thereby creating a path through body 110 (between ends 116b, 117b) to capture cavity 111. As will be described in more detail below, body 110 and segments 116, 117 are transitioned between the opened and closed positions by body actuation assembly 160. Although body 110 is a split ring adapted to open and close in this embodiment, in other embodiments, the body (e.g., body 110) is not a split ring, but rather, is a single annular component that is sized to receive the flange joint and is not configured to be opened and closed.

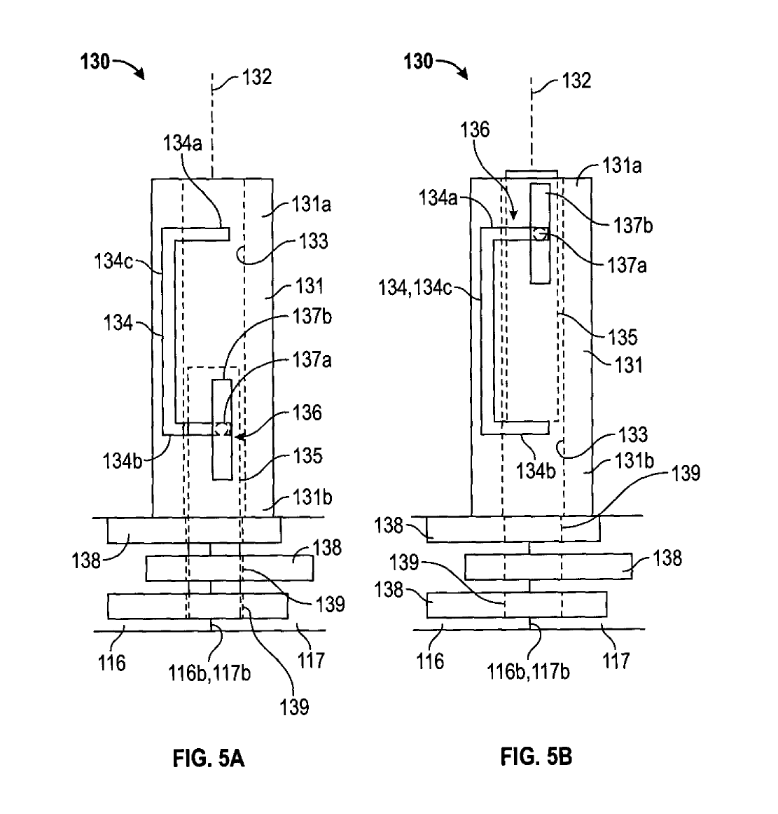

Referring now to FIGS. 1, 2, 5A, and 5B, in this embodiment, locking mechanism 130 includes a housing 131, a locking pin 135 coaxially disposed in housing 131, and a plurality of locking plates or arms 138 coupled to segments 116, 117. As best shown in FIGS. 5A and 5B, housing 131 is a tubular having a central or longitudinal axis 132, a first or upper end 131a, a second or lower end 131b, and a through bore 133 extending between ends 131a, b. In addition, housing 131 includes a through slot 134 extending radially from bore 133 to the radially outer surface of housing 131. Slot 134 includes a first circumferential portion 134a proximal upper end 131a, a second circumferential portion 134b proximal lower end 131b, and an axial transfer portion 134c extending axially between the ends of portions 134a, b.

Referring still to FIGS. 5A and 5B, an actuation member 136 is attached to locking pin 135 and is employed to move pin 135 axially within housing 131. Member 136 includes a cylindrical pin 137a and a handle 137b. Pin 137a slidingly engages slot 134 has a radially inner end attached to locking pin 135 and a radially outer end attached to handle 137b. Thus, pin 137a extends radially outward from locking pin 135 through slot 134 to handle 137b. Cylindrical locking pin 135 slidingly engages bore 133 and is free to move axially relative to housing 131 and rotate about axis 132 relative to housing 131. Locking pin 135 is moved axially through bore 133 by moving actuation pin 137a through slot 134 with handle 137b.

Referring again to FIGS. 2, 5A, and 5B, two locking arms 138 are attached to end 116b of segment 116, and one locking arm 138 is attached to end 117b of segment 117. Arms 138 extend radially outward from segments 116, 117, and circumferentially overlap when ends 116b, 117b are circumferentially adjacent. In particular, arms 138 are axially positioned such that arm 138 extending from end 117b is axially positioned between arms 138 extending from end 116b when ends 116b, 117b are moved circumferentially together. As best shown in FIGS. 5A and 5B, each arm 138 includes a bore 139 extending axially therethrough. Bores 139 are axially aligned when body 110 and segments 116, 117 are in the closed position (i.e., ends 116b, 117b are circumferentially adjacent).

Referring still to FIGS. 5A and 5B, locking pin 135 is moved into and out of bores 139 to transition locking mechanism 130 between the locked and unlocked positions, respectively. In the locked position shown in FIG. 5A, pin 137a is disposed in the lower circumferential portion 134b of slot 134 and locking pin 135 extends axially downward from lower end 131b of housing 131 through each bore 139; and in the unlocked position shown in FIG. 5B, pin 137a is disposed in the upper circumferential portion 134a of slot 134 and locking pin 135 is withdrawn axially upward from each bore 139 (i.e., locking pin 135 does not extend through any of bores 139). To transition locking mechanism 130 from the unlocked position (FIG. 5B) to the locked position (FIG. 5A), ends 116b, 117b are moved together to axially align bores 139. Then, handle 137b is used to move pin 137a circumferentially through slot portion 134a to transfer portion 134c. Locking pin 135 rotates about axis 132 relative to housing 131 as pin 137a is moved through slot portion 134a. Next, pin 137a is moved axially downward through transfer portion 134c with handle 137b, thereby moving locking pin 135 axially downward within bore 133. Pin 135 is sized such that it extends axially through each bore 139 when pin 137a is moved axially downward in transfer portion 134c from upper portion 134a to lower portion 134b. To ensure pin 135 is not inadvertently moved upward and withdrawn from bores 139 once locking mechanism 130 is locked, pin 137a is preferably moved circumferentially away from transfer portion 134c through lower portion 134b. To transition locking mechanism 130 from the locked position (FIG. 5A) to the unlocked position (FIG. 5B), handle 137b is used to move pin 137a circumferentially through slot portion 134b to transfer portion 134c. Locking pin 135 rotates about axis 132 relative to housing 131 as pin 137a is moved through slot portion 134b. Next, pin 137a is moved axially upward through transfer portion 134c with handle 137b, thereby moving locking pin 135 axially upward within bore 133. Pin 135 is sized such that it is withdrawn axially from each bore 139 when pin 137a is moved axially upward in transfer portion 134c from lower portion 134b to upper portion 134a. To ensure pin 135 is not inadvertently moved downward and dropped through bores 139 once locking mechanism 130 is unlocked, pin 137a is preferably moved circumferentially away from transfer portion 134c through upper portion 134a. It should be appreciated that locking pin 135 is housed within housing 131, and is prevented from disengaging or falling out of housing 131 by actuation member 136. This arrangement reduces the potential for the inadvertent loss (e.g., drop) of locking pin 135 subsea by an ROV.

Referring again to FIGS. 1-4, a plurality of circumferentially spaced guide feet 140 are attached to body 110. In particular, guide feet 140 extend radially outward and axially downward from body 110. In this embodiment, each foot 140 is the same. Namely, each foot 140 has an upper end 140a secured to outer surface 112b, a lower end 140b distal body 110, and a radial extension 141 axially positioned (relative to axis 115) between ends 140a,b. Each extension 141 extends radially inward along lower end 110b, but does not extend radially into capture cavity 111. A guide surface 142 extends from extension 141 to lower end 140b. The angle of guide surface 142 measured from axis 115 in side view is preferably between 30° and 60°. In this embodiment, angle measured from axis 115 to each guide surface 142 in side view is 45°. As will be described in more detail below, when tool 100 is lowered onto a flange joint, feet 140, and more specifically surfaces 142, guide tool 100 into coaxial alignment with the joint for subsequent flange separation and retrieval operations.

Referring still to FIGS. 1-4, a plurality of circumferentially-spaced support frames 150 extend radially outward from body 110. In this embodiment, four uniformly circumferentially-spaced support frames 150 are provided (i.e., frames 150 are angularly spaced 90° apart about axis 115). Each support frame 150 has a central or longitudinal axis 155, first or radially inner end 150a secured to body 110, and a second or radially outer end 150b distal body 110. Axes 155 are oriented perpendicular to outer surface 112b. In addition, a projection of each axis 155 intersects axis 115 when body 110 is in the closed position (FIGS. 1, 3, and 4). In this embodiment, each actuator support frame 150 includes a pair of parallel elongate arms 151 attached to body 110 and extending axially (relative to axis 155) between ends 150a, b, a base plate 152 extending laterally between the bottom of arms 151, and an end plate 153 extending laterally between ends 150b of arms 151. In this embodiment, each arm 151 and end plate 153 is oriented vertically in a plane parallel to axis 115, and each base plate 152 is oriented horizontally in a plane perpendicular to axis 115. For each support frame 150, arms 151, base plate 152, and end plate 153 are orthogonal. A handle 154 is coupled to each support frame 150 at end 150b. In addition, a handle 156 is coupled to select arms 151 and extends laterally therefrom. Handles 154, 156 enable subsea manipulation of tool 100 with ROVs.

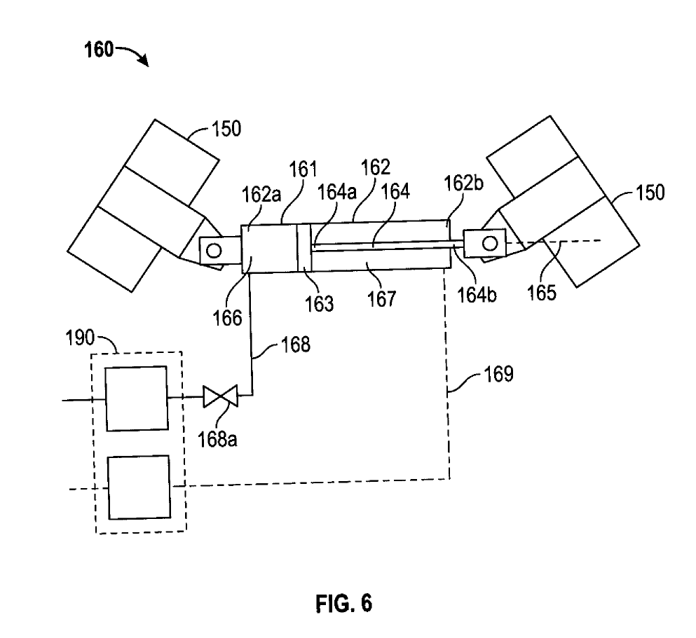

Referring now to FIGS. 1, 2, and 6, tool 100, body 110, and segments 116, 117 are transitioned between the opened and closed positions by body actuation assembly 160. In this embodiment, assembly 160 includes a linear actuator 161, a first hydraulic line 168, and a second hydraulic line 169. Lines 168, 169 are shown in FIG. 6. In FIGS. 1-4, lines 168, 169 have been removed for purposes of clarity.

As best shown in FIG. 6, in this embodiment, actuator 161 is a double-acting, hydraulic piston-cylinder assembly including a cylinder 162, a piston 163 slidingly disposed in cylinder 162, and a rod 164 extending from piston 163 through cylinder 162. Cylinder 162 has a central axis 165, a first end 162a, and a second end 162b opposite first end 162a. Rod 164 extends axially from piston 163 and through end 162b of cylinder 162. In particular, rod 164 is coaxially aligned with cylinder 162, and has a first end 164a coupled to piston 163 and a second end 164b distal piston 163. Ends 162a, 164b are pivotally coupled to circumferentially adjacent support frames 150 that circumferentially straddle hinge 118 (i.e., on opposite sides of hinge 118 as shown in FIGS. 1 and 2). Thus, ends 162a, 164b are allowed to pivot relative to corresponding frames 150.

Piston 163 is disposed in cylinder 162 between ends 162a, b, and divides the inside of cylinder 162 into a first chamber 166 extending axially from piston 163 to end 162a, and a second chamber 167 extending axially from piston 163 to end 162b. Hydraulic lines 168, 169 are connected to chambers 166, 167, respectively, and are configured to (a) supply pressurized hydraulic fluid to chambers 166, 167, respectively; and (b) receive hydraulic fluid from chambers 166, 167, respectively. In other words, line 168 can supply pressurized hydraulic fluid to chamber 166, and receive pressurized hydraulic fluid from chamber 166, and line 169 can supply pressurized hydraulic fluid to chamber 167, and receive pressurized hydraulic fluid from chamber 167. In this embodiment, hydraulic fluid is provided to and received from lines 168, 169 via a subsea “hot stab” coupling 190 (FIGS. 1 and 2).

Referring still to FIG. 6, piston 163 is moved axially through cylinder 162 by creating a pressure differential across piston 163 and between chambers 166, 167. For example, to move piston 163 within cylinder 162 towards end 162a, pressurized hydraulic fluid is provided to chamber 167 via line 169, and hydraulic fluid in chamber 166 is allowed to exit chamber 166 via line 168 as the volume of chamber 166 decreases; and to move piston 163 within cylinder 162 towards end 162b, pressurized hydraulic fluid is provided to chamber 166 via line 168, and hydraulic fluid in chamber 167 is allowed to exit chamber 167 via line 169 as the volume of chamber 167 decreases.

Rod 164 moves axially along with piston 163. Thus, axial movement of piston 163 within cylinder 162 causes rod 164 to axially extend and retract relative to cylinder 162. Cylinder 162 sealingly engages rod 164, and thus, fluid communication between chamber 167 and the external environment is restricted and/or prevented. As rod 164 extends axially from cylinder 162 (i.e., piston 163 moves to the right in FIG. 6), ends 162a, 164b are moved axially away from each other; and as rod 164 is axially retracted into cylinder 162 (i.e., piston 163 moves to the left in FIG. 6), ends 162a, 164b are moved axially towards each other. Due to the pivotal connection between ends 162a, 164b and corresponding frames 150, as ends 162a, 164b move axially relative to each other, segments 116, 117 pivot about axis 119, thereby opening and closing body 110. In particular, to move ends 116b, 117b together to close body 110, ends 162a, 164b are moved axially away from each other with actuator 161, and to move ends 116b, 117b apart to open body 110, ends 162a, 164b are moved axially towards each other with actuator 161.

In this embodiment, first hydraulic line 168 includes a valve 168a that controls the flow of hydraulic fluid through line 168. In particular, when valve 168a is open, hydraulic fluid is free to flow into or out of chamber 166 via line 168, and when valve 168a is closed, hydraulic fluid is restricted and/or prevented from flowing into or out of chamber 166 via line 168. Thus, when valve 168a is open, piston 163 can be moved axially within cylinder 162 (in either direction), however, when valve 168a is closed, piston 163 is restricted and/or prevented from axially moving within cylinder 162 (in both directions) due to hydraulic lock. In general, valve 168a may comprise any suitable valve for controlling fluid flow through line 168 including, without limitation, a ball valve, a gate valve, or a butterfly valve. In this embodiment, valve 168a is a ball valve. As best shown in FIG. 1, in this embodiment, valve 168a is manually actuated using an actuation handle 168b that is rotated in a first direction by a subsea ROV to open valve 168a, and rotated in the opposite direction to close valve 168a.

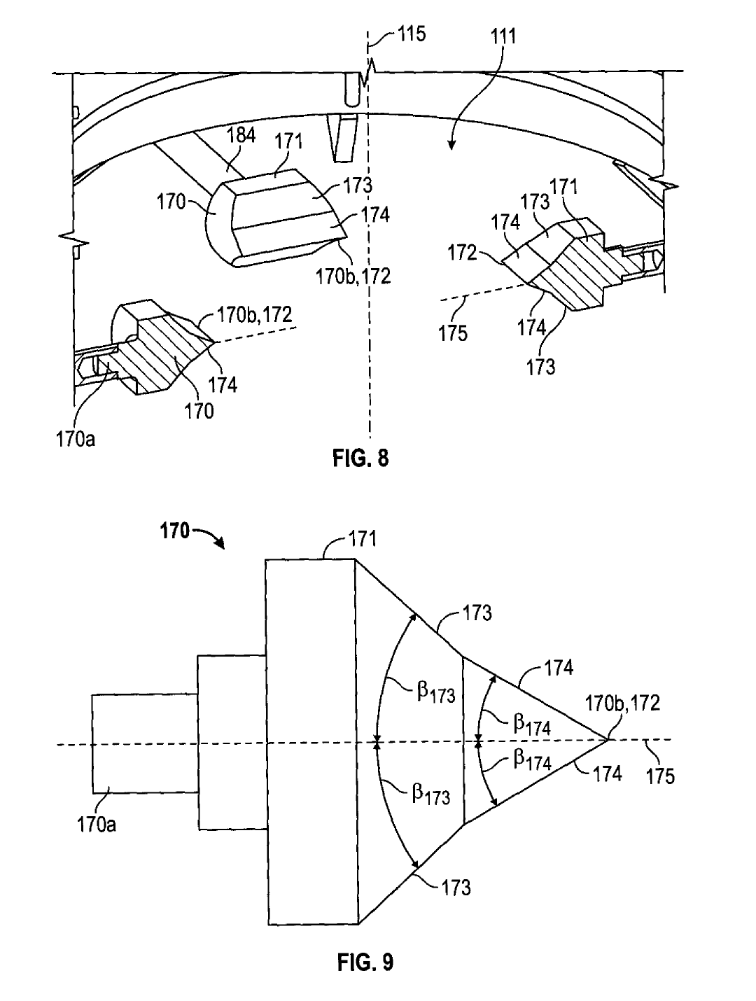

Referring now to FIGS. 7-9, wedge members 170 are moved radially inward by actuation assembly 180 from a first position radially withdrawn from capture cavity 111 (relative to axis 115) to a second position radially advanced into capture cavity (relative to axis 115). With wedge members 170 aligned with an interface between two flanges of a joint seated in capture cavity 111, wedge members 170 urge the flanges apart as they move from the radially withdrawn position to the radially advanced position. In this embodiment, when body 110 is closed, wedge members 170 are uniformly angularly spaced about axis 115, and further, each wedge member 170 is radially opposed one other wedge member 170.

Each wedge member 170 has a central axis 175, a first end 170a, and a second end 170b. When body 110 is closed, axis 175 of each wedge member 170 is radially oriented such that a projection of axis 175 intersects axis 115. As a result of this orientation, end 170a may also be described as a radially outer end, and end 170b may also be described as a radially inner end. In addition, each wedge member 170 includes a base 171 proximal end 170a, a crest or edge 172 at end 170b, a first pair of planar flanking surfaces 173 extending axially from base 171, and a second pair of planar flanking surfaces 174 extending axially between edge 172 and flanking surfaces 173. Wedge members 170 are positioned and oriented such that each edge 172 lies in a common plane perpendicular to axis 115. Flanking surfaces 173 taper or incline towards one another as they extend from base 171. Likewise, flanking surfaces 174 taper or incline towards one another as they extend from surfaces 173 to edge 172. As best shown in FIG. 9, planar flanking surfaces 173 are oriented at an angle β₁₇₃ relative to axis 175 in side view, and flanking surfaces 174 are oriented at an angle β₁₇₄ relative to axis 175 in side view. Angle β₁₇₄ is preferably less than angle β₁₇₃. In addition, angle β₁₇₃ is preferably between 30° and 60°, and angle β₁₇₄ is preferably between 15° and 45°. In this embodiment, angle β₁₇₃ is 45°, and angle β₁₇₄ is 30°. Although wedge members 170 include flanking surfaces 173, 174 oriented at different angles relative to axis 175 in this embodiment, in other embodiments, the wedge members may only include one pair of flanking surfaces (e.g., arrow shaped), or three or more pairs of flanking surfaces, each oriented at a different angle relative to the central axis.

As will be described in more detail below, during flange separation operations, wedge members 170 are disposed about the flange joint and moved radially inward with actuation assembly 190. Edges 172 are positioned at the interface between mating flanges of a flange joint and urged radially inward therebetween. Without being limited by this or any particular theory, during separation of most subsea flange joints, the initial break of the flanges requires the most axial force. Accordingly, configuring wedge members 170 such that the leading flanking surfaces 174 are disposed at a lower angle β₁₇₄ facilitates the initial separation of the flanges, and the trailing flanking surfaces 173 disposed at a relatively higher angle β₁₇₃ facilitates the subsequent lifting of one flange from the other flange. In particular, the relatively low angle surfaces 174 (i.e., oriented at 30°) allow wedge members 170 to be started into the interface between flanges with a minimal amount of material deformation until a sufficient separation can be achieved.

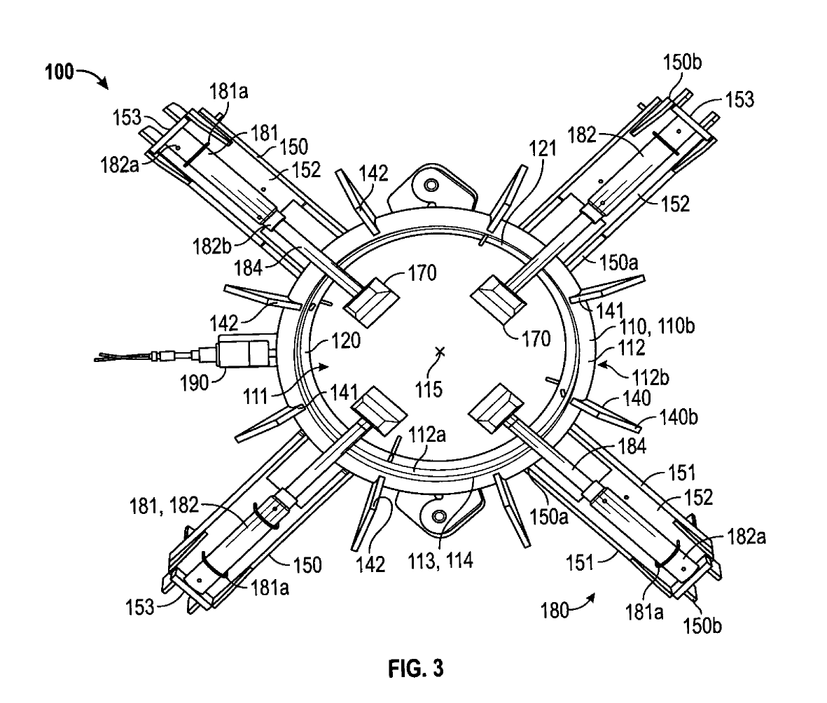

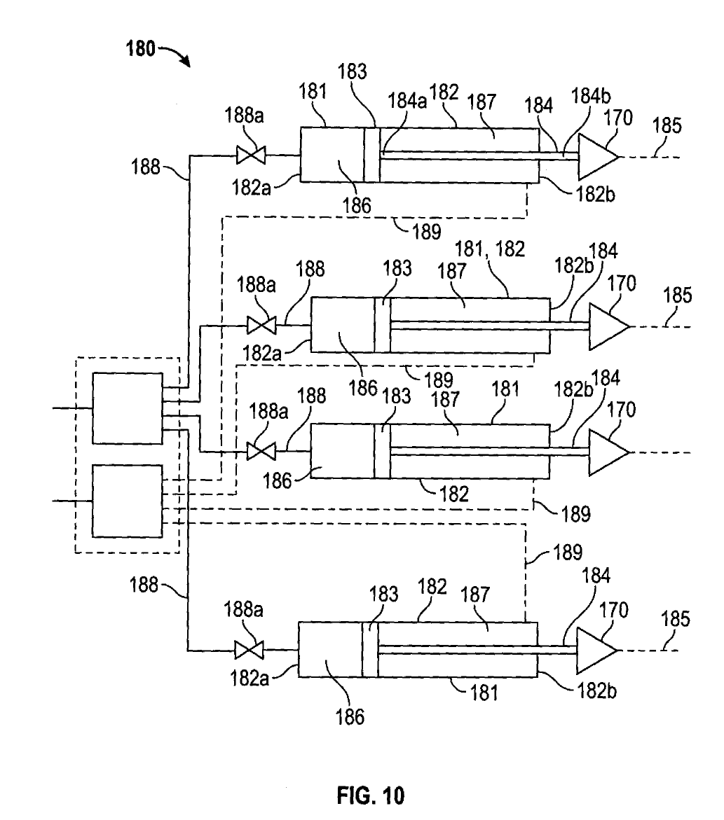

Referring now to FIGS. 3, 4, and 10, wedge members 170 are moved radially inward and outward relative to axis 115 by actuation assembly 180. As best shown in FIG. 10, in this embodiment, assembly 180 includes a plurality of linear actuators 181, a first hydraulic line 188 coupled to each actuator 181, and a second hydraulic line 189 coupled to each actuator 181. In FIGS. 1-4, lines 188, 189 have been removed for purposes of clarity. As best shown in FIG. 3, one actuator 181 is coupled to each support frame 150. More specifically, each actuator 181 is coupled to base plate 152 of its corresponding frame 150 with one or more coupling members 181a. In this embodiment, each coupling member 181a is a u-bolt extending around its corresponding actuator 181 and having ends secured to its corresponding base plate 152.

Referring specifically to FIG. 10, in this embodiment, actuators 181 are substantially the same as actuators 161 previously described. Namely, each actuator 181 is a double-acting, hydraulic piston-cylinder assembly including a cylinder 182, a piston 183 slidingly disposed in housing 182, and a rod 184 extending from piston 183 through cylinder 182. Each cylinder 182 has a central axis 185, a first end 182a axially abutting corresponding end plate 153, and a second end 182b opposite first end 182a. Each cylinder 182 is oriented such that its axis 185 is parallel to axis 155 of its corresponding frame 150. Thus, when body 110 is closed, each cylinder 182 is radially oriented such that a projection of its axis 185 intersects axis 115. One rod 184 extends axially from each piston 183 and through end 182b of the corresponding cylinder 182. In particular, each rod 184 is coaxially aligned with its corresponding cylinder 182, and has a first end 184a coupled to piston 183 and a second end 184b coupled to one wedge 170.

Referring still to FIG. 10, one actuator 181 will now be described in more detail, with the understanding that each actuator 181 is configured the same. Piston 183 is disposed in cylinder 182 between ends 182a, b, and divides the inside of cylinder 182 into a first chamber 186 extending axially from piston 183 to end 182a, and a second chamber 187 extending axially from piston 183 to end 182b. Hydraulic lines 188, 189 are connected to chambers 186, 187, respectively, and are configured to (a) supply pressurized hydraulic fluid to chambers 186, 187, respectively; and (b) receive hydraulic fluid from chambers 186, 187, respectively. In other words, line 188 can supply pressurized hydraulic fluid to chamber 186, and receive pressurized hydraulic fluid from chamber 186, and line 189 can supply pressurized hydraulic fluid to chamber 187, and receive pressurized hydraulic fluid from chamber 187. In this embodiment, hydraulic fluid is provided to and received from lines 188, 189 via a subsea “hot stab” coupling 190 (FIGS. 1 and 2).

Piston 183 is moved axially through cylinder 182 by creating a pressure differential across piston 183 and between chambers 186, 187. For example, to move piston 183 within cylinder 182 towards end 182a, pressurized hydraulic fluid is provided to chamber 187 via line 189, and hydraulic fluid in chamber 186 is allowed to exit chamber 186 via line 188 as the volume of chamber 186 decreases; and to move piston 183 within cylinder 182 towards end 182b, pressurized hydraulic fluid is provided to chamber 186 via line 188, and hydraulic fluid in chamber 187 is allowed to exit chamber 187 via line 189 as the volume of chamber 187 decreases.

Rod 184 moves axially along with piston 183. Thus, axial movement of piston 183 within cylinder 182 causes rod 184 to axially extend and retract relative to cylinder 182. Cylinder 182 sealingly engages rod 184, and thus, fluid communication between chamber 187 and the external environment is restricted and/or prevented. As rod 184 extends axially from cylinder 182 (i.e., piston 183 moves to the right in FIG. 10), wedge member 170 moves radially inward towards axis 115; and as rod 184 is axially retracted into cylinder 182 (i.e., piston 183 moves to the left in FIG. 10), wedge member 170 moves radially outward relative to axis 115.

Referring still to FIG. 10, in this embodiment, each hydraulic line 188 includes a valve 188a as previously described that controls the flow of hydraulic fluid through that line 188. In particular, when a given valve 188a is open, hydraulic fluid is free to flow into or out of chamber 186 via the corresponding line 188, and when a given valve 188a is closed, hydraulic fluid is restricted and/or prevented from flowing into or out of chamber 186 via the corresponding line 188. Thus, when a given valve 188a is open, the corresponding piston 183 can be moved axially within its cylinder 182 (in either direction), however, when that valve 188a is closed, the corresponding piston 183 is restricted and/or prevented from axially moving within its cylinder 182 (in both directions) due to hydraulic lock. In general, each valve 188a may comprise any suitable valve for controlling fluid flow through line 168 including, without limitation, a ball valve, a gate valve, or a butterfly valve. In this embodiment, each valve 188a is a ball valve. As best shown in FIG. 1, in this embodiment, each valve 188a is a manually actuated using an actuation handle 188b that is rotated in a first direction by a subsea ROV to open valve 188a, and rotated in the opposite direction to close valve 188a. To minimize differences in hydraulic pressure supplied among different actuators 181, each line 188, 189 has the same length.

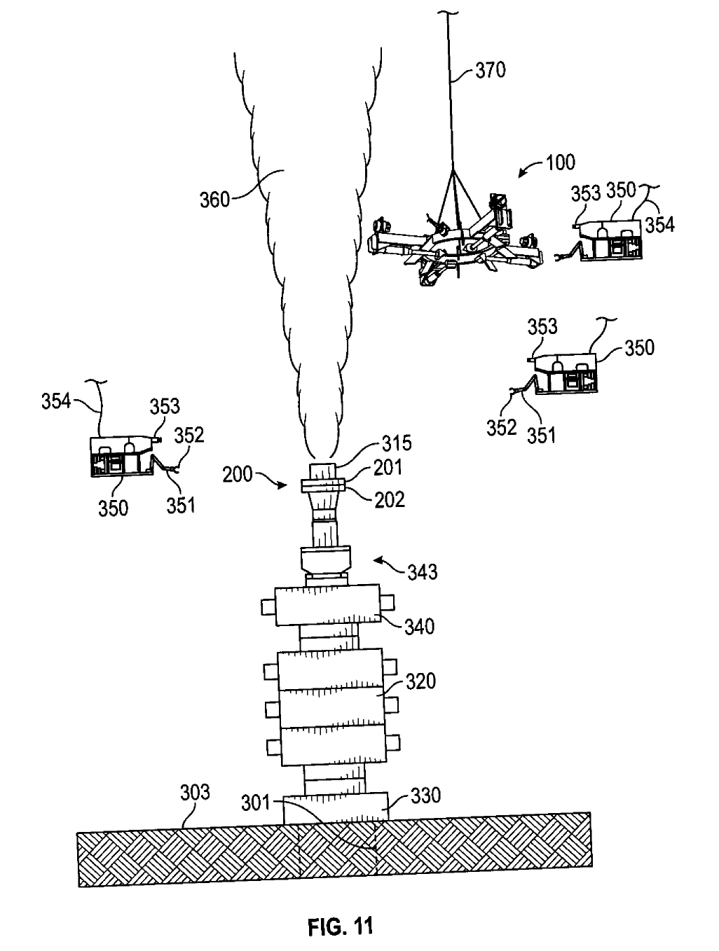

Referring now to FIGS. 11-17, tool 100 is shown being deployed and operated subsea to engage, separate, and retrieve an upper flange 201 of a flange joint 200 formed by a lower flange 202 and upper flange 201. In this embodiment, flange joint 200 forms the connection between a subsea flex joint 343 and the lower end of a riser 315. In particular, a subsea blowout preventer (BOP) 320 is mounted to a wellhead 330 at the sea floor 303, and a lower marine riser package (LMRP) 340 is secured to BOP 320. Riser 315 typically extends from LMRP 340 to a floating platform at the sea surface. However, as shown in FIGS. 11-17, riser 315 has been severed proximal joint 200. BOP 320 and LMRP 340 are configured to controllably seal wellbore 301 and contain hydrocarbon fluids therein. The upper end of LMRP 340 comprises riser flex joint 343 that allows riser 315 to deflect angularly relative to BOP 320 and LMRP 340 while hydrocarbon fluids flow from wellbore 301, BOP 320 and LMRP 340 into riser 315.

During a “kick” or surge of formation fluid pressure in wellbore 301, one or more rams of BOP 320 and/or LMRP 340 are normally actuated to seal in wellbore 301 and protect personnel and hardware upstream of BOP 320 and LMRP 340. However, in some cases, BOP 320 and/or LMRP 340 may unable to contain wellbore 301, resulting in a blowout. Such a blowout may damage BOP 320, LMRP 340, and riser 315. Damage to subsea BOP 320, LMRP 340, or riser 315 may result in the discharge of such hydrocarbon fluids subsea. The emitted hydrocarbons fluids form a subsea hydrocarbon plume 360 that extends to the sea surface.

For subsea deployment and operation, one or more remote operated vehicles (ROVs) are preferably employed to position and monitor tool 100. In this embodiment, three ROVs 350 are employed to position and/or monitor tool 100. Each ROV 350 includes an arm 351 having a claw 352, a subsea camera 353 for viewing the subsea operations (e.g., the relative positions of tool 100 and joint 200, the positions and movement of arms 350 and claws 352, etc.), and an umbilical 354. Streaming video and/or images from cameras 353 are communicated to the surface or other remote location via umbilical 354 for viewing on a live or periodic basis. Arms 351 and claws 352 are controlled via commands sent from the surface or other remote location to ROV 350 through umbilical 354.

Referring first to FIG. 11, in this embodiment, wireline 370 is removably secured to body 110 of tool 100 via connection members 125 (FIGS. 1 and 2), body 110 is in the closed position with locking mechanism 130 (FIGS. 1 and 2) in the locked position (FIG. 5A), and valves 168a, 188a (FIGS. 6 and 10) are closed. Valves 168a, 188a may be closed at the surface prior to deployment, or subsea with one or more ROVs 350. Tool 100 is controllably lowered subsea with wireline 370, which extends from tool 100 to a surface vessel. A winch or crane mounted to a surface vessel is preferably employed to support and lower tool 100 on wireline 370. Tool 100 is lowered laterally offset from joint 200 and outside of plume 360 until guide feet 140 are slightly above joint 200. As tool 100 descends and approaches joint 200, ROVs 350 monitor the position of tool 100 relative to joint 200.

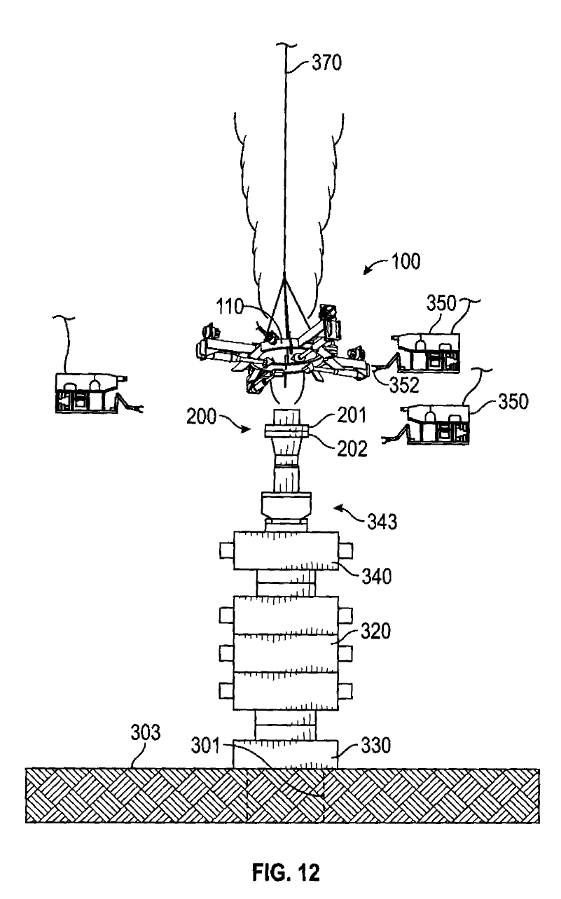

Next, as shown in FIG. 12, tool 100 is moved laterally into position immediately above joint 200 with body 110 substantially coaxially aligned with joint 200. One or more ROVs 350 may utilize their claws 352 and handles 154, 156 (FIGS. 1 and 2) to guide and position tool 100 relative to joint 200. Due to its own weight, tool 100 is substantially vertical, whereas joint 200 may be oriented at an angle relative to vertical. Thus, it is to be understood that perfect coaxial alignment of housing 110 and joint 200 may be difficult.

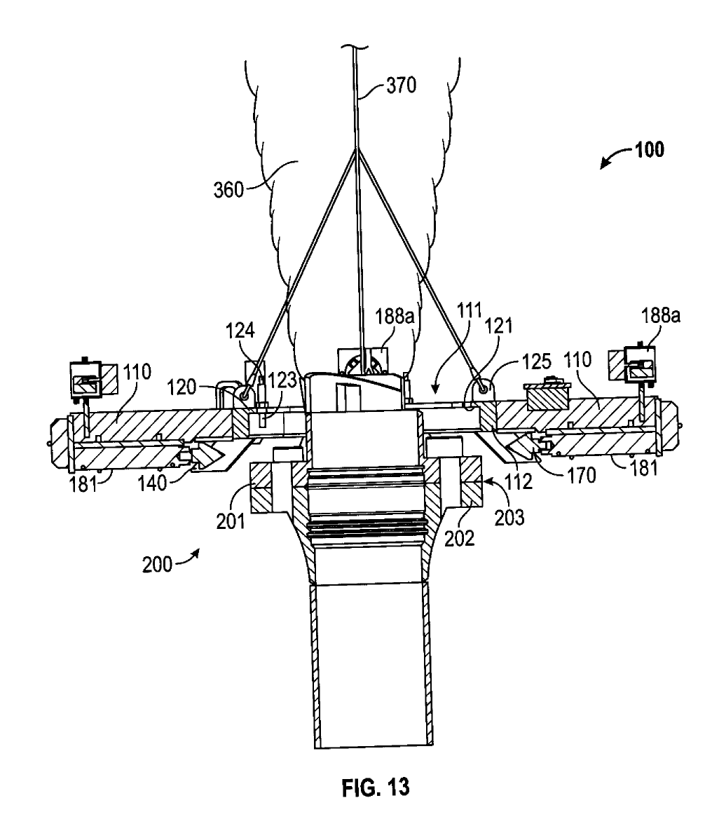

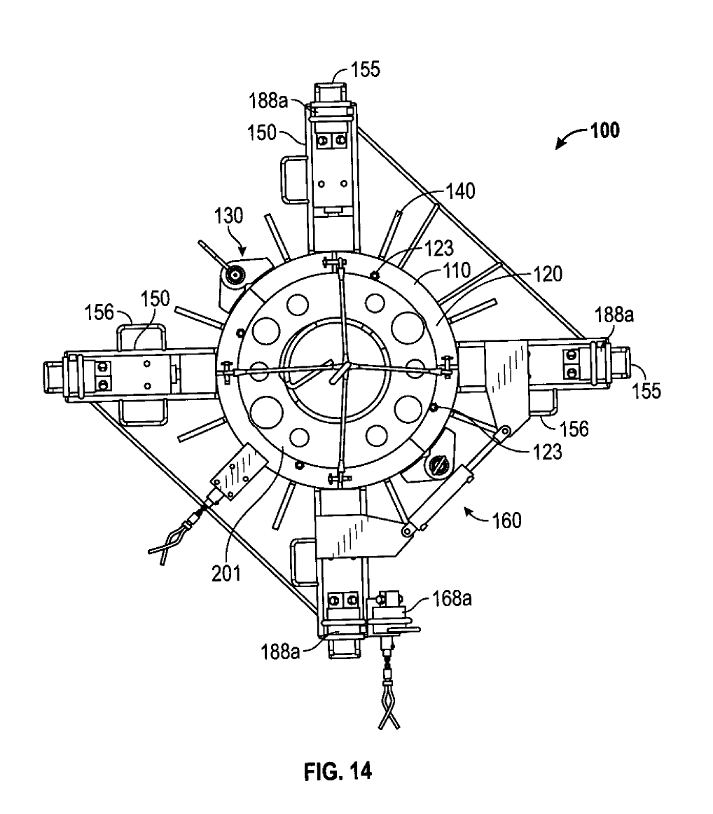

Moving now to FIGS. 13 and 14, with tool 100 positioned immediately above joint 200, and housing 110 and joint 200 generally coaxially aligned, wireline 370 sets tool 100 axially downward, thereby receiving upper flange 201 into body 110 and capture cavity 111. Prior to lowering tool 100 onto flange 201, the bolts securing flanges 201, 202 are removed such that flange 201 can be axially lifted and removed from flange 202 with tool 100 as will be described in more detail below. The bolts securing flanges 201, 202 may be removed by any suitable means including, without limitation, by an ROV operated torque tool.

As tool 100 is set down onto flange 201, feet 140, and in particular guide surfaces 142 (FIGS. 1-4), help to guide and funnel upper flange 201 into body 110 and capture cavity 111. This may be particularly beneficial in cases where housing 110 is not perfectly coaxially aligned with joint 200 as tool 100 is lowered over upper flange 201. As tool 100 is positioned over joint 200 and lowered onto upper flange 201, hydrocarbon fluids flowing from joint 200 are allowed to flow unrestricted through tool 100, thereby relieving well pressure and offering the potential to reduce the resistance to the coupling of tool 100 to flange 201.

As best shown in FIGS. 13 and 14, body 110 is sized and configured such that the inner diameter of first portion 112 is slightly greater than the outer diameter of upper flange 201 and the inner diameter of second portion 120 is less than the outer diameter of upper flange 201. As a result, the lower ends of bolts 123 extending axially from shoulder 121 axially abut flange 201 as flange 201 is axially received into body 110. Upper flange 201 is preferably coaxially advanced into body 110 until flange 201 axially abuts and engages the lower ends of one or more bolts 123.

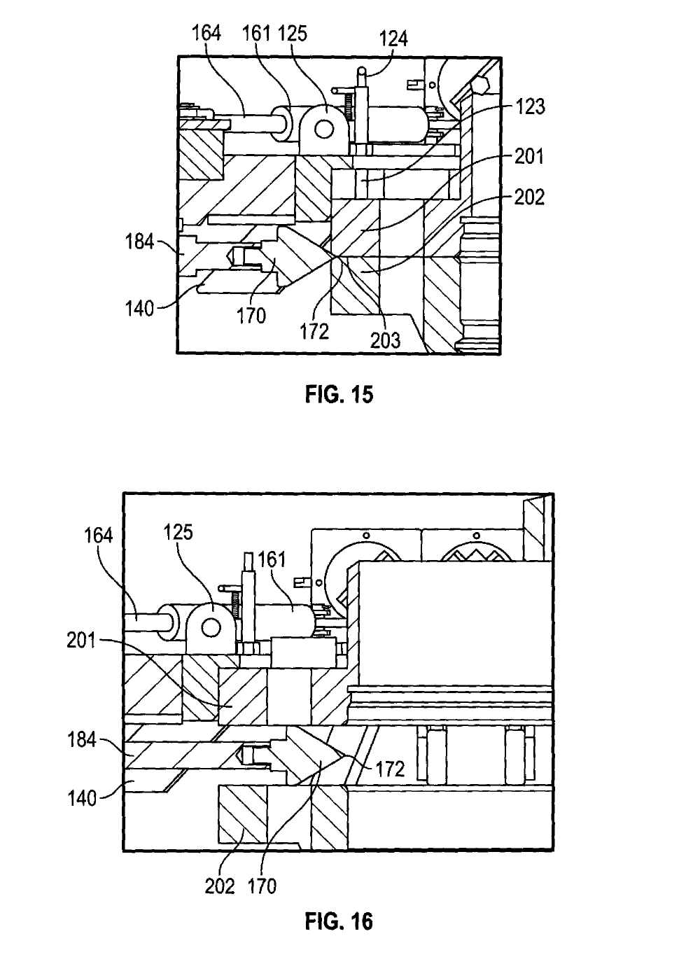

Referring now to FIG. 15, each bolt 123 is rotated by ROVs 350 via handles 124 to adjust the axial position of tool 100 relative to joint 200 such that each edge 172 is axially aligned with the annular interface 203 between flanges 201, 202. Next, each wedge member 170 is radially advanced one at a time such that edges 172 are pushed radially against interface 203. As previously described, each valve 188a is closed (prior to deployment or subsea via ROVs 350), thereby preventing the actuation of wedge members 170. Thus, a first valve 188a associated with a first cylinder 182 is opened with an ROV 350, pressurized hydraulic fluid is provided to chamber 186 via line 188, and hydraulic fluid is allowed to exit chamber 187 via line 189, thereby moving the associated wedge member 170 radially inward into engagement with interface 203. Next, that first valve 188a is closed, and a second valve 188a associated with a second cylinder 182 is opened with an ROV 350, pressurized hydraulic fluid is provided to chamber 186 via line 188, and hydraulic fluid is allowed to exit chamber 187 via line 189, thereby moving the associated wedge member 170 radially inward into engagement with interface 203. This process is repeated for each wedge member 170.

As best shown in FIGS. 15 and 16, with edge 172 of each wedge member 170 in engagement with interface 203, ROVs 350 open each valve 188a, and pressurized hydraulic fluid is provided to each chamber 186 via lines 188, and hydraulic fluid allowed to exit each chamber 187 via lines 189, to urge wedge members 170 between flanges 201, 202. As wedge members 170 move radially inward between flanges 201, 202, flange 201 is separated and moved axially from flange 202.

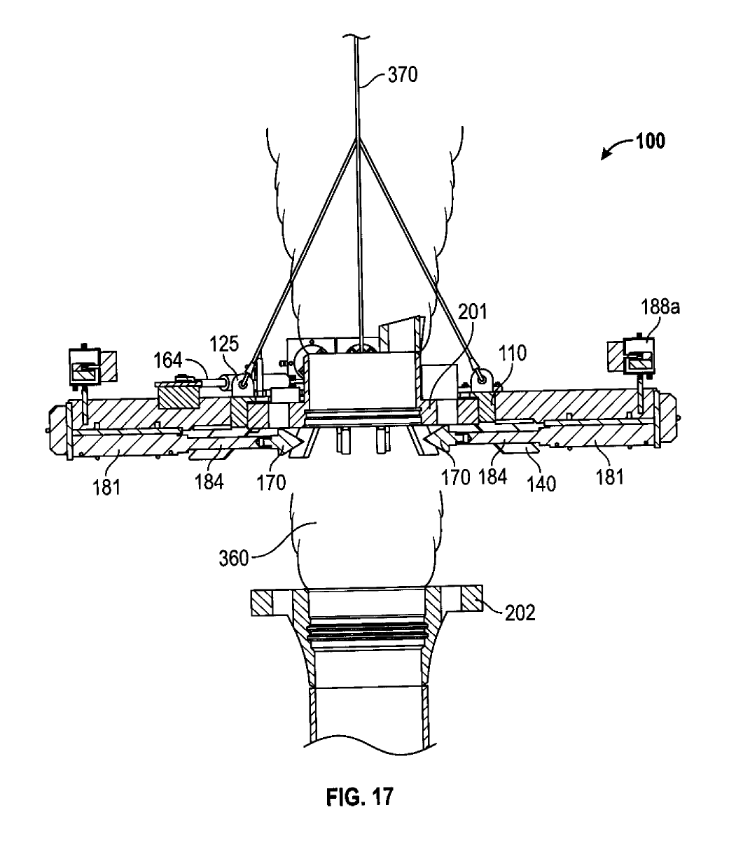

Moving now to FIG. 17, with flange 201 axially separated from flange 202 and each wedge member 170 positioned below flange 201, a lifting or pulling force is applied to tool 100 with wireline 370 to separate or remove tool 100 together with flange 201 from flange 202. Flange 201 may be released or removed from tool 100 by radially withdrawing wedge members 170 with actuators 181, opening body 110, or combinations thereof at the surface or at another subsea location.

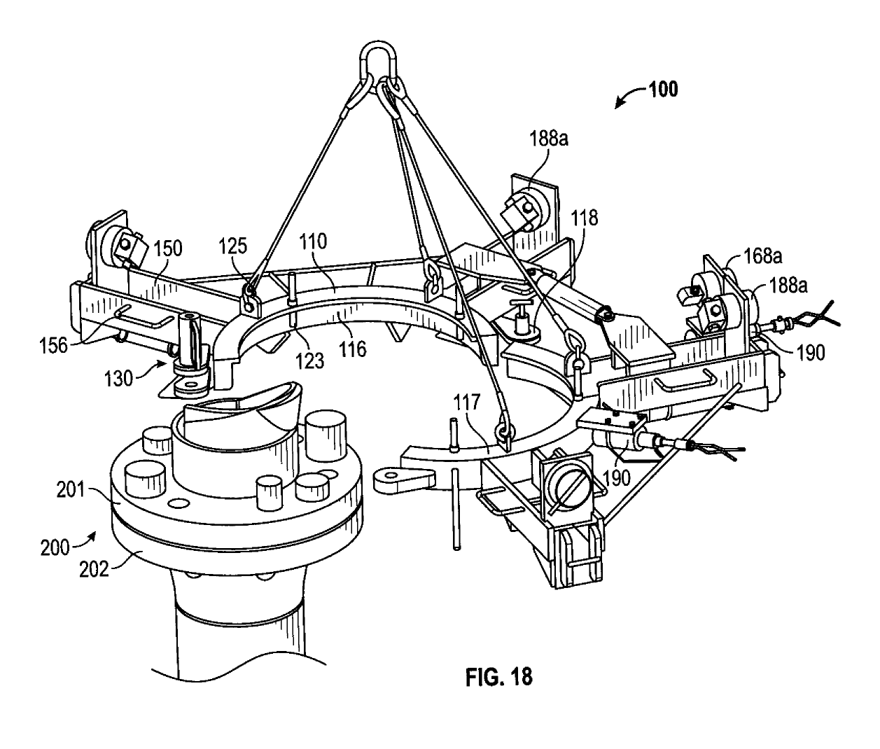

As previously described, tool 100 is seated on flange joint 200 with body 110 in the closed position by positioning tool 100 axially above joint 200, coaxially aligning body 110 and joint 200, and then lowering tool 100 onto joint 200, thereby allowing flange 201 to be received into body 110 and cavity 111. However, tool 100 may also be disposed about joint 200 with body 110 in the open position, and then transitions to the closed position and locked, thereby capturing in flange 201 within body 110 and capture cavity 111. For example, referring briefly to FIG. 18, locking mechanism 130 is unlocked and body 110 is opened by (a) opening valve 168a, (b) applying pressurized hydraulic fluid to chamber 167 via line 169, (c) allowing hydraulic fluid to exit chamber 166 via line 168, and (d) extending rod 164 from cylinder 162. Body 110 may be opened at the surface prior to deployment, or subsea after deployment (e.g., an ROV 350 may be used to open valve 168a). Next, tool 100 is positioned laterally adjacent joint 200 with body 110 generally axially aligned with flange 201, and tool 100 is moved laterally toward joint 200 such that flange 201 is received between segment ends 116b, 117b (FIG. 2). With flange 201 positioned between segments 116, 117, body 110 is closed by (a) opening valve 168a if it is not already open (FIG. 6), (b) applying pressurized hydraulic fluid to chamber 166 via line 168 (FIG. 6), (c) allowing hydraulic fluid to exit chamber 167 via line 169 (FIG. 6), and (d) retracting rod 164 into cylinder 162 until ends 116b, 117b abut (FIG. 6). Then, ROVs 350 transition locking mechanism 130 to the locked position. With flange 201 disposed in capture cavity 111 the same procedures as previously described with respect to FIGS. 15-17 are repeated to separate and remove upper flange 201 from lower flange 202. Although embodiments of tool 100 are shown and described as removing a flange from a flange joint that is discharging hydrocarbons subsea, it should be appreciated that embodiments described herein may also be employed to remove a flange from a flange joint that is not emitting hydrocarbons.

In some cases, tool 100 may not be able to sufficiently separate and/or remove upper flange 201 subsea once wedge members 170 are forced between flanges 201, 202. For example, wedge members 170 may get stuck between flanges 201, 202. In such cases, it is generally desirable to remove tool 100 from upper flange 201 so that another tool or procedure may be employed to remove flange 201. Accordingly, in this embodiment, tool 100 may be removed from upper flange 201 once it has been seated within body 110 and wedge members 170 are in engagement with interface 203 or disposed between flanges 201, 202. In particular, coupling members 181a associated with each stuck wedge member 170 are cut by an ROV 350, lines 188, 189 associated with each stuck wedge member 170 are removed or cut from the corresponding actuators 181, and then tool 100 is lifted or removed from flange 201 leaving the stuck wedge members 170 and associated actuators 181 behind.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A tool for separating a first flange from a second flange, the tool comprising:
an annular body disposed about a central axis and defining a flange capture cavity;
a plurality of circumferentially-spaced wedge members moveably coupled to the body;
a first actuation assembly configured to move each wedge member from a first position radially withdrawn from the capture cavity to a second position radially advanced into the capture cavity.

2. The tool of claim 1, wherein the first actuation assembly is configured to move each wedge member from the second position to the first position.

3. The tool of claim 1, wherein the first actuation assembly comprises:
a plurality of linear actuators, wherein each linear actuator is configured to move one wedge member from the first position to the second position.

4. The tool of claim 3, wherein each linear actuator comprises a double-acting piston cylinder assembly including a cylinder having a longitudinal axis, a piston slidably disposed within the cylinder, and an elongate rod coaxially aligned with the cylinder and having a first end coupled to the piston and a second end coupled to one wedge member;
wherein a projection of the longitudinal axis of each cylinder intersects the central axis of the body.

5. The tool of claim 4, wherein each cylinder has a first end and a second end opposite the first end;
wherein the piston of each linear actuator divides the cylinder into a first chamber extending axially from the piston to the first end of the cylinder and a second chamber extending axially from the piston to the second end of the cylinder;
wherein the first actuation assembly further comprises a pair of hydraulic lines for each linear actuator, wherein each pair of hydraulic lines includes a first hydraulic line coupled to the first chamber of the cylinder and a second hydraulic line coupled to the second chamber of the cylinder.

6. The tool of claim 5, wherein the first hydraulic line of each pair of hydraulic lines includes a valve configured to control the flow of hydraulic fluid through the first line.

7. The tool of claim 1, wherein the body has a first end, a second end axially opposite the first end, a first portion extending axially from the second end and a second portion extending radially inward from the first portion at the first end;
wherein an intersection between the first portion and the second portion defines a radially inner annular shoulder on the body;
wherein the second portion includes a plurality of internally threaded through bores extending axially through the second portion from the first end to the annular shoulder;
wherein a bolt threadingly engages each bore, wherein each bolt includes a handle extending axially from the first end.

8. The tool of claim 1, wherein the body is a split-ring including a first arcuate segment and a second arcuate segment, wherein each segment has a first end and a second end opposite the first end;
wherein the first end of the first segment is pivotally coupled to the first end of the second segment;
wherein the second end of the first segment is releasably coupled to the second end of the second segment.

9. The tool of claim 8, wherein each arcuate segment extends angularly 180° about the central axis of the body.

10. The tool of claim 8, wherein a locking mechanism releasably locks the second end of the first arcuate segment to the second end of the second arcuate segment.

11. The tool of claim 8, wherein the body has an open position with the second end of the first arcuate segment spaced apart from the second end of the second arcuate segment and a closed position with the second end of the first arcuate segment circumferentially adjacent the second end of the second arcuate segment.

12. The tool of claim 11, further comprising a second actuation assembly coupled to the body and configured to transition the body between the open position and the closed position.

13. The tool of claim 12, wherein the second actuation assembly comprises:
a linear actuator configured to pivot the first arcuate segment relative to the second arcuate segment;
wherein the linear actuator comprises a double-acting piston cylinder assembly including a cylinder having a longitudinal axis, a piston slidably disposed within the cylinder, and an elongate rod coaxially aligned with the cylinder and having a first end coupled to the piston and a second end distal the piston;
wherein the cylinder has a first end and a second end opposite the first end;
wherein the first end of the cylinder is pivotally coupled to the first arcuate segment and the second end of the rod is pivotally coupled to the second arcuate segment.

14. The tool of claim 13, wherein the piston of the linear actuator divides the cylinder into a first chamber extending axially from the piston to the first end of the cylinder and a second chamber extending axially from the piston to the second end of the cylinder;
wherein the second actuation assembly further comprises a first hydraulic line coupled to the first chamber of the cylinder and a second hydraulic line coupled to the second chamber of the cylinder;
wherein the first hydraulic line of each pair of hydraulic lines includes a valve configured to control the flow of hydraulic fluid through the first line.

15. The tool of claim 3, wherein each wedge member has a central axis, a first end coupled to one of the linear actuators, and a second end opposite the first end;
wherein each wedge member comprises an edge at the second end, a first pair of flanking surfaces extending from the edge, and a second pair of flanking surfaces extending from the first pair of flanking surfaces.

16. The tool of claim 15, wherein the first pair of flanking surfaces are oriented at a first angle measured from the central axis in side view, and wherein the second pair of flanking surfaces are oriented at a second angle measured from the central axis in side view, wherein the second angle is greater than the first angle.

17. A method for separating a first flange of a subsea flange joint from a second flange of the subsea flange joint, the method comprising:
(a) lowering a flange splitting tool subsea, wherein the tool comprises:
an annular body disposed about a central axis and defining a flange capture cavity;
a plurality of circumferentially-spaced wedge members moveably coupled to the body, wherein each wedge member includes a pair of flanking surfaces defining an edge;
(b) positioning the first flange within the capture cavity;
(c) aligning the edge of each wedge member with an interface between the first flange and the second flange; and
(d) urging the wedge members radially inward between the first flange and the second flange after (c).

18. The method of claim 17, wherein the edge of each wedge member is aligned with the interface during (c) one wedge member at a time.

19. The method of claim 17, wherein (b) further comprises positioning the tool over the subsea flange joint and lowering the tool onto the first flange; and
wherein (c) further comprises adjusting the axial position of the body relative to the first flange.

20. The method of claim 19, wherein (b) further comprises guiding the first flange into the flange capture cavity with a plurality of circumferentially spaced guide feet coupled to the body.

21. The method of claim 17, further comprising:
(e) removing the first flange from the flange joint with the tool after (d).

22. The method of claim 17, wherein the tool is lowered subsea with a wireline.

23. The method of claim 17, wherein the body comprises a first segment and a second segment, wherein each segment has a first end and a second end opposite the first end;
wherein the first end of the first segment is pivotally coupled to the first end of the second segment;
wherein the second end of the first segment is releasably coupled to the second end of the second segment.

24. The method of claim 23, wherein (b) comprises:
(b1) positioning the body laterally adjacent the flange joint;
(b2) opening the body by moving the second end of the first segment from the second end of the second segment;
(b3) moving the body laterally to receive the first flange between the second end of the first segment and the second end of the second segment after (b2);
(b4) closing the body by moving the second end of the first segment to the second end of the second segment after (b3); and
(b5) locking the second end of the first segment to the second end of the second segment after (b4).

25. A method for operating a flange separation tool, comprising:
(a) positioning the flange separation tool proximal to a subsea flange joint including a first flange coupled to a second flange, wherein the tool comprises:
an annular body disposed about a central axis and defining a flange capture cavity;
a first wedge member moveably couple to the body;
a second wedge member moveably coupled to the body and circumferentially spaced from the first wedge member;
wherein each wedge member includes a radially inner edge;
(b) receiving the first flange into the capture cavity;
(c) adjusting the axial position of the wedge members relative to an interface between the first flange and the second flange;
(d) moving the first wedge member radially inward until the edge of the first wedge member engages the interface;
(e) moving the second wedge member radially inward after (d) until the edge of the second wedge member engages the interface; and
(f) simultaneously moving each wedge member radially inward between the first wedge member and the second wedge member after (e).

26. The method of claim 25, further comprising:
(g) decoupling each wedge member from the body after (f); and
(h) removing the body from the first flange after (g).

27. The method of claim 25, wherein the body has an upper end, a lower end, a first portion extending axially from the lower end, and a second portion extending radially inward from the first portion at the upper end;
wherein an intersection between the first portion and the second portion defines a radially inner annular shoulder on the body;
wherein the second portion includes a plurality of internally threaded through bores extending axially through the second portion from the upper end to the annular shoulder;
wherein a bolt threadingly engages each bore.

28. The method of claim 27, wherein (b) comprises positioning the body about the first flange;
wherein (c) comprises:
engaging the first flange with each bolt; and
rotating one or more bolts with one or more subsea remotely operated vehicles
to move the wedges axially relative to the interface.

29. The method of claim 25, wherein the tool further comprises:
a third wedge member moveably coupled to the body and a fourth wedge moveably coupled to the body;
wherein each wedge member includes a radially inner edge;
wherein the wedge members are uniformly circumferentially spaced.

30. The method of claim 29, further comprising:
moving the third wedge member radially inward after (e) until the edge of the third wedge member engages the interface; and
moving the fourth wedge member radially inward after moving the third wedge member radially inward until the edge of the fourth wedge member engages the interface.

31. The method of claim 25, wherein (c) to (f) are performed by one or more subsea remotely operated vehicles.
